(19) United States
(12) Patent Application Publication
(10) Pub. No.: US 2002/0107719 A1
(43) Pub. Date: Aug. 8, 2002

(54) System of analyzing networked searches within business markets

(76) Inventors: You Mon Tsang, San Francisco, CA (US); Daniel Gartung, Hillsborough, CA (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/779,216

(22) Filed: Feb. 7, 2001

(51) Int. Cl. G06F 17/60

(52) U.S. Cl. 705/10

(57) ABSTRACT

A method and system that electronically searches documents for information that pertains to business research over a network. This method and system allows for a user to personally access (via a secure and privileged network connection) its easily accessible networked site. According to one embodiment of the invention, the automated Market Metrics and Analysis System aggregates and cleans data gathered from its networked sources. A component in the Market Metrics and Analysis System cleans the aggregated data while a data warehouse stores the cleansed data. Another component of the Market Metrics and Analysis System generates a data analysis from the stored data found in the data warehouse. Based on this data analysis, the Market Metrics and Analysis System generates a reporting analysis for the user of the system, which is based on the results of the previously performed data analysis.

### FIELD OF THE INVENTION

The present invention relates to the field of electronic commerce. More specifically, a system that allows for the electronic searching of documents over a network, that pertains to the researching user-specified business enterprises.

### BACKGROUND OF THE INVENTION

Businesses today compete in an accelerated economy where business models and strategies change very quickly. The growth of the Internet has provided businesses with a means of easily tapping in to many different information sources. However, much of the information that is useful to such enterprises is spread out amongst sources that are too numerous to exploit intelligently. In their efforts to stay abreast of developments in the marketplace, most businesses are faced with the daunting challenge of gauging its rapid changes, and responding to them quickly and effectively. This problem is exacerbated by the presence of so many information sources.

Currently available networked web-based systems provide for user services such as data aggregation, data storing, data cleaning, text analysis, and general searching. They do not offer the type of enterprise-class data analysis and reporting tools that provide business enterprises with the level of analysis necessary to take advantage of the information available. Businesses need analytical tools that enable them to (1) better understand their market and market players, (2) to measure and increase market effectiveness, and (3) to quickly expose market threats and opportunities. The currently available systems are not desirable for such purposes, because they lack not only the capacity to track user's concerns, but also the interactive analysis and reporting necessary to adequately address such problems.

### BRIEF SUMMARY OF THE INVENTION

A method and system that electronically searches documents for information that pertains to business research over a network is described. This method and system allows for a user to personally access (via a secure and privileged network connection) its easily accessible networked site. According to one embodiment of the invention, the automated Market Metrics and Analysis System aggregates and cleans data gathered from its networked sources. A component in the Market Metrics and Analysis System cleans the aggregated data while a data warehouse stores the cleansed data. Another component of the Market Metrics and Analysis System generates a data analysis from the stored data found in the data warehouse. Based on this data analysis, the Market Metrics and Analysis System generates a reporting analysis for the user of the system, which is based on the results of the previously performed data analysis.

### BRIEF DESCRIPTION OF THE DRAWINGS

The invention may best be understood by referring to the following description and accompanying drawings that are used to illustrate embodiments of the invention. In the drawings:

FIG. 1 depicts an exemplary conventional digital processing system in which the present invention can be implemented.

FIG. 2 is a diagram representing the basic logical structure of the Market Metrics and Analysis System of the present invention.

FIG. 3 is a diagram showing the functional relationship between a Market Metrics and Analysis System 300 and other components necessary to conduct market metric-related searches upon a web-based system.

FIG. 4 illustrates some of the operations performed by the web-based Market Metrics and Analysis System of FIG. 3.

FIG. 4A illustrates additional operations performed by the web-based Market Metrics and Analysis System of FIG. 3.

FIG. 4B illustrates exemplary operations performed by the web-based Market Metrics and Analysis System of FIG. 3 if user is not satisfied with original search results, according to one embodiment of the invention.

FIG. 5 is an example user-interface screen on the Market Metrics and Analysis System web site that prompts the user to complete input fields that are necessary to complete the desired search.

FIG. 6 is an additional example user-interface screen on the Market Metrics and Analysis System website that prompts the user to complete input fields that are necessary to properly and effectively calculate mindshare.

FIG. 7 is an example user-interface screen on the Market Metrics and Analysis System web site that displays to the user the summary of a publication that is related to the user's search.

FIG. 8 is an additional example user-interface screen on the Market Metrics and Analysis System web site that textually and graphically displays to the user a summary of a multitude of criteria pertaining to the user's search.

### DETAILED DESCRIPTION OF THE INVENTION

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

A method and apparatus for an automated system that increases marketing effectiveness is described. This invented Market Metrics and Analysis System (MMAS) provides for a multitude of marketing services within a networked web-based environment. Services include a continuous aggregation of content specific marketing information pertaining to a specific business industry, the competitors in that industry, and any products/issues that may be involved. Other services include a data analysis system that cleans and enhances the above-mentioned information and alerts clients of the MMAS of any possible business concerns. In one embodiment, the system's client base may include any business that desires to better understand their market and market players, measure and increase marketing effectiveness, and quickly expose market threats and opportunities. A few of the interactive reporting and analysis applied in the alert system includes:. current mindshare, awareness of competitors over time and any new upcoming competitors that may be a threat in the shared marketplace.

Mindshare is a direct function of attention and reach. It is the percentage of each visitor's total tracked viewing time spent at a given website, summed up for all visitors and divided by the total number of unique visitors. The result for each company is a percentage of mindshare from the tracked audience. Tracking mindshare is important because market share usually follows the evolution of mindshare. A good mindshare that indicates such reach, attention and immersion is considered an effective predictor of market share. Thus, a careful mindshare analysis enables companies to look for ways of improving their market share.

The MMAS analyzes a defined collection of data through (1) complex web extraction (2) cleansing (3) data analysis and mining (4) business rules (5) search and query (6) reporting modules and (7) metrics. In one embodiment, the MMAS has identified a departmental module as marking and an industry module of high-tech and entertainment. However, it should be understood that the MMAS could leverage its core technology into many industries and across many departments inside a business enterprise. For example, as a first step, create a generic expandable foundation of MMAS's technology and a resulting solution. Then, focus and tune the solution by targeting at a specific department in a few industries and add additional information sources and text analysis modules for additional industries (e.g., from consumer products to travel to financial services or even politics). All of which are built on the same MMAS technology foundation.

The Market Metrics and Analysis System of the present invention can also target additional departments within an enterprise by developing new data analyses and reports. Departments may include finance, research and development, customer support and more. While this requires some specific domain knowledge, it also uses the same technology base as the already existing original departments. Any additional department introduced immediately becomes available for all industries. This process can be repeated for departments and industries based on the original technical platform.

The techniques shown in the figures herein can be implemented using code executed and data stored on computers. Such conventional computers store and communicate (internally and with other computers over a network) code and data using machine-readable media, such as magnetic disks; optical disks; random access memory; read only memory; flash memory devices; electrical, optical, acoustical or other form of propagated signals (e.g., carrier waves, infrared signals, digital signals, etc.); etc. Of course, one or more parts of the invention may be implemented using any combination of software, firmware, and/or hardware.

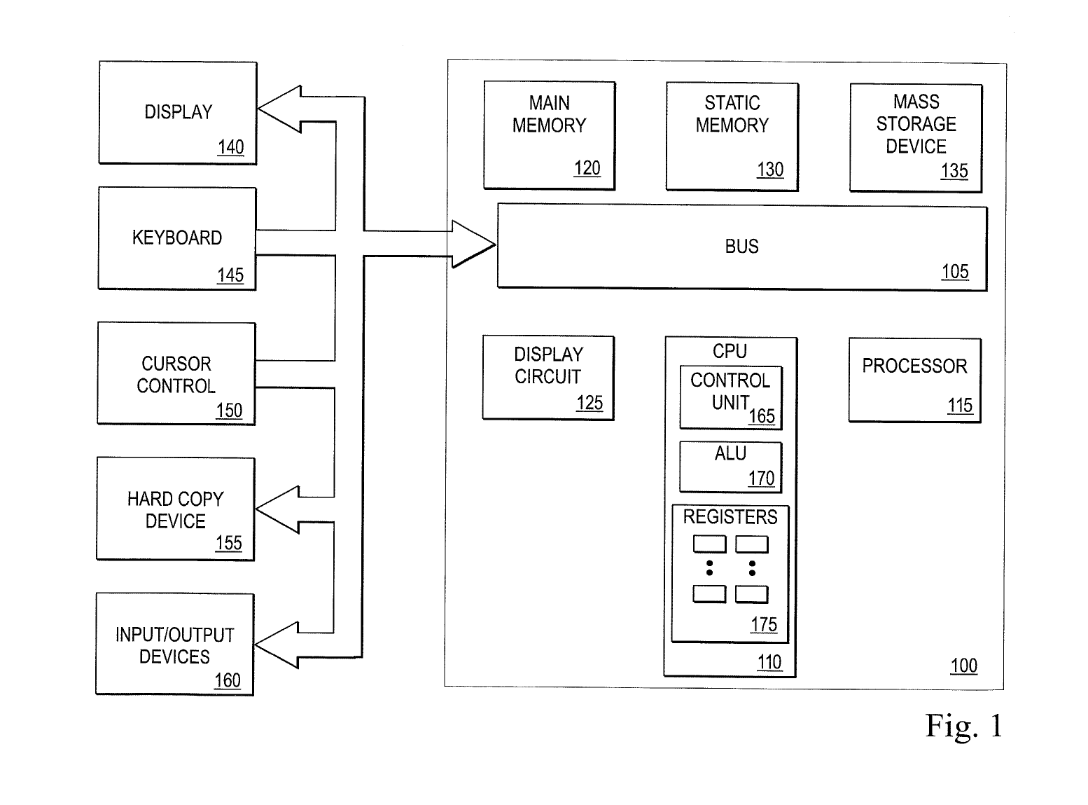

FIG. 1 depicts an exemplary conventional digital processing system 100 in which the present invention can be implemented. For one embodiment, the instruction re-alignment techniques can be implemented on a personal computer architecture. Referring to FIG. 1, digital processing system 100 includes a bus 105 or other communication means for communicating information, and a central processing unit (CPU) 110 coupled with bus 105 for processing information. CPU 110 includes a control unit 165, an arithmetic logic unit (ALU) 170, and several registers 175. For example, registers 175 may include predicate registers, spill and fill registers, floating point registers, integer registers, general registers, and other like registers. CPU 110 can be used to implement the instruction re-alignment techniques described herein. Furthermore, another processor 115 such as, for example, a coprocessor, can be coupled to bus 105 for additional processing power and speed.

Digital processing system 100 also includes a main memory 120, which may be a random access memory (RAM) or some other dynamic storage device, which is coupled to bus 105. Main memory 120 may store information and instructions to be executed by CPU 110. Main memory 120 may also store temporary variables or other intermediate information during execution of instructions by CPU 110. Digital processing system 100 also includes a static memory 130 such as, for example, a read only memory (ROM) and/or other static storage device, that is coupled to bus 105 for storing static information and instructions for CPU 110. A mass storage device 135, which may be a hard or floppy disk drive, can also be coupled to bus 105 for storing information and instructions.

A display 140, such as a cathode ray tube (CRT), can be coupled to bus 105. Display device 140 is used to display information to a computer user. A keyboard 145 or other alphanumeric input device may also be coupled to bus 105 for communicating information and command selections to CPU 110. A cursor control 150, such as a mouse, a track ball, or cursor direction keys, may be coupled to bus 105 for communicating direction information and command selections to CPU 110 and for controlling cursor movement on display 140. Another device that may be coupled to bus 105 is hard copy device 155 which may be used for printing instructions, data, or other information on paper, film, or some other storage medium. A number of input/output devices 160 may also be coupled to bus 105.

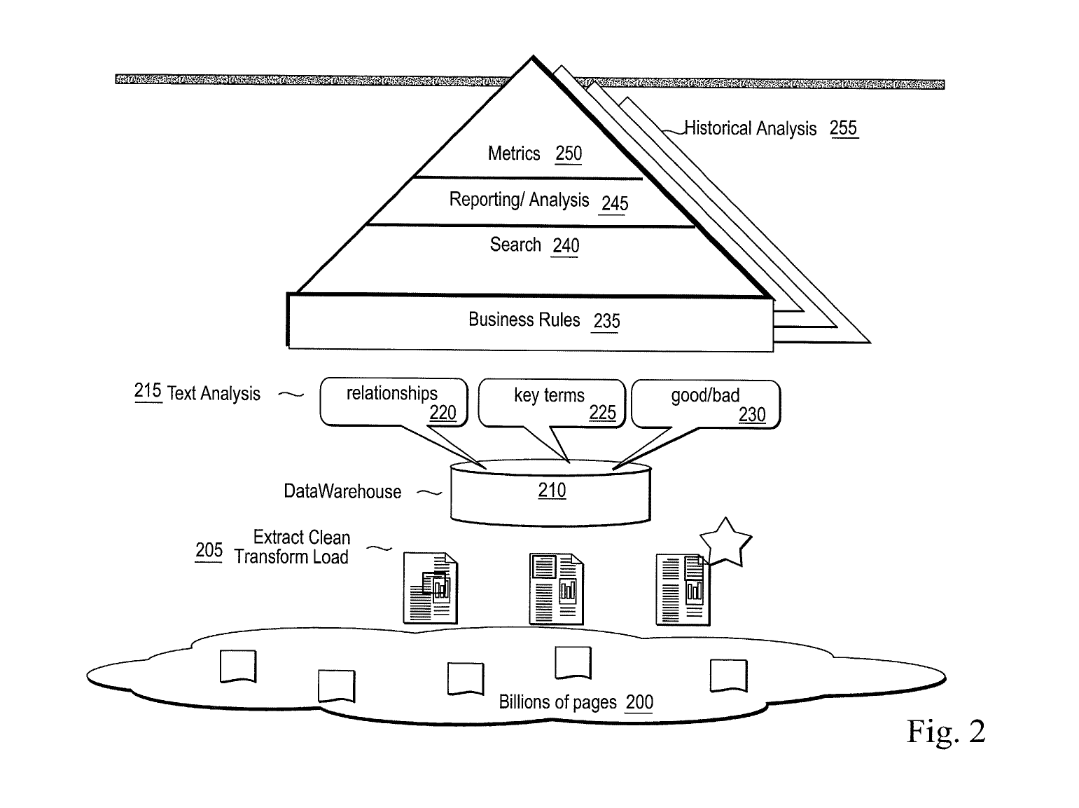

FIG. 2 is a diagram representing the basic logical structure of the Market Metrics and Analysis System of the present invention. In this embodiment, the MMAS is implemented on a networked web-based system to conduct a broad, external search of millions of web-pages 200 found on an Intemetwork (e.g., the Internet). For example, the Internet is gathering the world's thoughts and is the untiring recorder of real-time information. The Internet gives users across the world access to over a billion web documents and a half of a million new daily newsgroup messages, thousands of online news sources, reader discussions sites, and opinion sites. The abovementioned external search is often implemented logically external to the MMAS and does not conduct a narrowly tailored search according to user-specific terms, relationships, etc. The MMAS performs multiple tasks upon the resultant web-pages arising from the external search, including: (1) extracting them (2) cleaning them (3) transforming them and (4) loading them 205 upon an electronic medium for storage in a data warehouse 210 (e.g., Oracle).

The purpose of FIG. 2 is to show in one embodiment of the invention, an overall diagram representing the MMAS and some applications of its tools. For example, the MMAS conducts a search 240 within a data warehouse 210. This search is denoted as an internal search because it is a narrowly tailored search that is in accordance with specific terms, relationships, etc. specified by the user. Each of these tools will be further explained herein. An internal search 240 of the data warehouse 210 may include the utilization of business rules 235 and a text analysis 215, which is in direct relation with the searching specifications given by the user of the system. This data analysis 215 application is shown to include a more tailored search using functions such as: relationships 220, key terms 225 and a prominence 230 determination. Once an internal search 240 is completed, its results are reported 245 to the user over the web-based system (e.g., via web-page access). An additional action labeled as metrics 250 may apply to any given search along with its historical analysis 255. These actions (e.g., metrics and historical analysis) help format the results of the reports and metrics so that it is more beneficial to the user of the system. As stated previously, the description of FIG. 1 is only one embodiment of the invention and its functions will be further explained below.

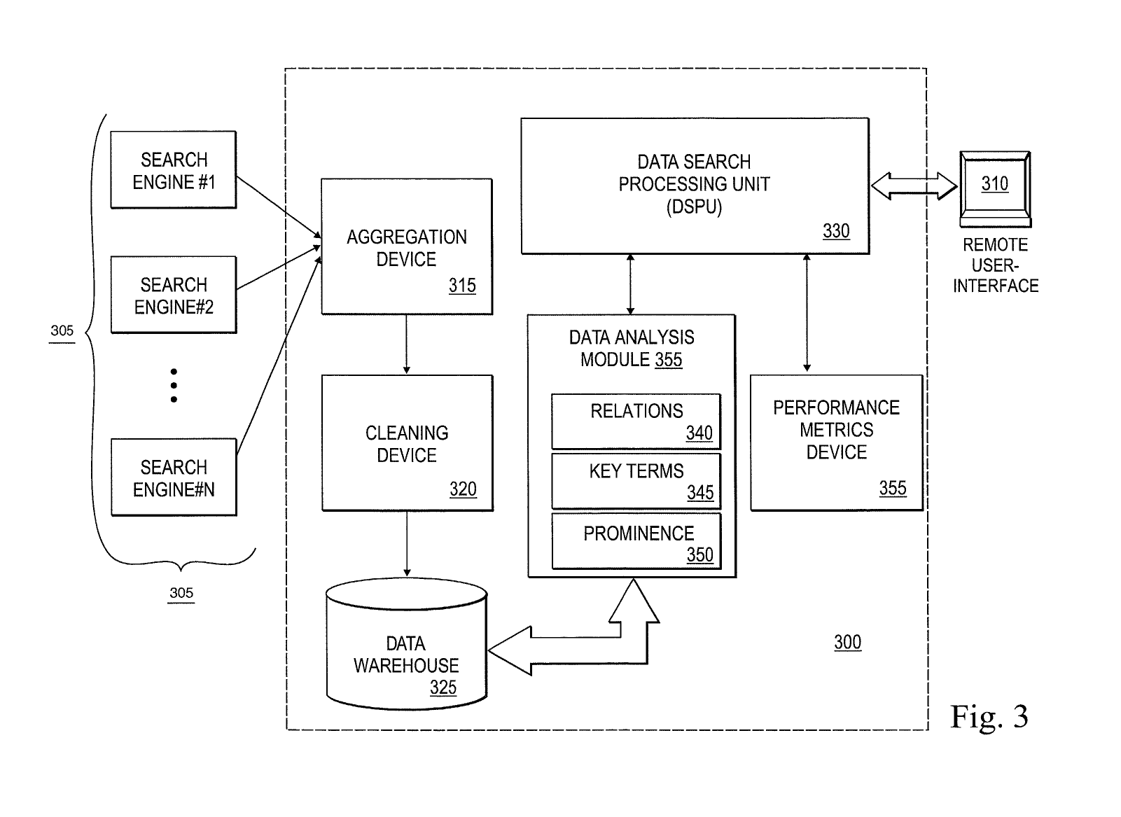

FIG. 3 is a diagram showing the functional relationship between a Market Metrics and Analysis System 300 and other components necessary to conduct market metric-related searches upon a web-based system. It should be understood that the components shown herein are functional in nature and may be implemented by using software and/or hardware, as the Figures in this application demonstrate one embodiment of the invention. In the illustrated embodiment, the MMAS 300 is shown to accept inputs from multiple search engines 305 (e.g., CNET Search, Yahoo, etc.) and from a remote user interface 310 (e.g., Intemetwork connection), which are necessary components of the web-based system. Both of these components are external to the MMAS 300 and may be physically located remotely from the system.

The MMAS 300 consists of six major components in one embodiment: an aggregation device 315, a cleaning device 320, a data warehouse 325, a data search-processing unit 330, a data analysis module 335 and a performance metrics device 355. These components are internal to the MMAS 300 and either directly or indirectly connects with the data search-processing unit (hereinafter “DSPU”) 330. The data search-processing unit 330 processes data that is internally inputted by each of the above-mentioned devices. The DSPU 330 outputs its search results to the user via a remote user interface. As shown, the aggregation device 315 collects data (i.e., text and media) from a multitude of sources, in one embodiment, which may include many search engines 305. It should be understood that the MMAS 300 may conduct these searches using its own search engines 305 or may purchase this information from other business enterprises that specialize in searching web-based systems (e.g., CNET Search, Yahoo, etc.).

The cleaning device 320 performs multiple functions, which includes the processes of extracting, cleaning, transforming and loading the web-page data gathered by the aggregation device 315. This cleansed data gathered by the MMAS 300 is stored in a data warehouse 325, which may be located external at a remote location or internal to the Marketing Response System 300. In either instance, the communication between the data warehouse 325 and any connections it may have with other components in the system are protected (e.g., via a protected and/or privileged IP link). According to the input by user (i.e., client) at a remote user interface 310, the data search-processing unit 330 will access the data stored in the data warehouse 325 for processing a search. The DSPU 330 utilizes the data analysis module 335, the performance metrics device 355 and accesses its data warehouse 325 upon every search initiated by the user at the remote user interface 310.

The data search-processing unit 330 is responsible for performing many different functions. Among these functions is the constant interaction/ communication with the remote user interface (i.e., client of the searching system) and any search engines 305 used in the system. It may seem when viewing the Figure that all components of the MMAS 300 are contained within a single housing. However, it should be understood that each of these components shown in the MMAS 300 (i.e., aggregation device, cleaning device, DSPU, data warehouse, data analysis module and performance metrics device) could be implemented in one housing, however its not limited to that single implementation. For example, any given component could be located at remote locations, where communication with the remainder of the system would take place over a communication link, satellite, wireless network, etc.

The data search-processing unit 330 accepts input from a multitude of locations, including a remote user interface 310. The remote user interface 120 may consist of, but not limited to, a single computer that has established a connection with a network, such as the Internet (e.g., by a dial-up connection) through the use of an Internet Service Provider. This remote user interface 310 provides for a connection between the client-user of the system and the data search-processing unit 330. The MMAS 300 provides a website, accessible via the Internet by using an Internet browser (e.g., Microsoft Internet Explorer), that accepts submitted information from the client-user and display at the remote user interface 310 the status of the search and its results.

For example, user submits a specific search request of the MMAS 300 at the user's remote user interface 310. The MMAS 300 accepts this request and processes it by accessing its data warehouse 325 and searches all data found therein according to the user's specified search parameters by accessing both the data analysis module 335 and the performance metrics device 355. Upon access of the data analysis module 335 by the DSPU 330, pluralities of data analysis functions are triggered, where one or more will be applied to assist in conducting the search. Depending on the desired type of search requested by the user, the DSPU 330 might apply the relationships module 340, the key terms module 345 and/or the prominence module 350.

Irrespective of which modules are applied in assisting the search by the data analysis module 335, the DSPU 330 must access the performance metrics device 355 after the search is completed. This performance metrics device 355 takes the resulting information from the applied searches and puts it into a specific web-based format according to the format requested by user. This format including all information gathered by the MMAS 300 is outputted on its own web site (as discussed previously), which grants access to the user at the remote user interface 310.

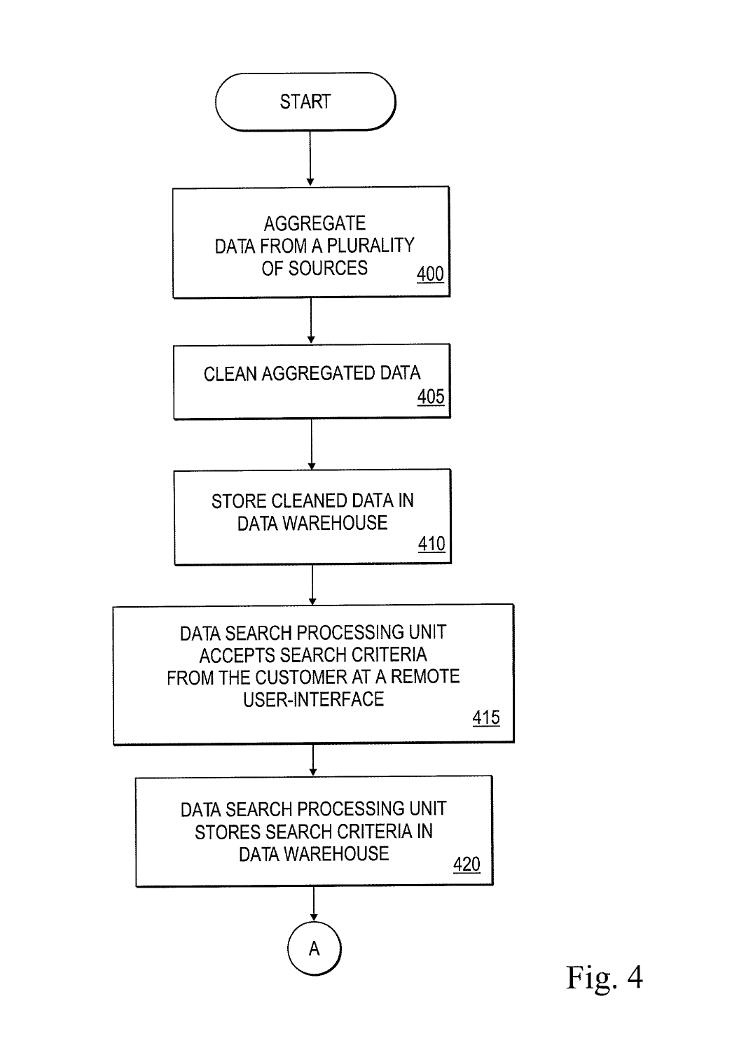

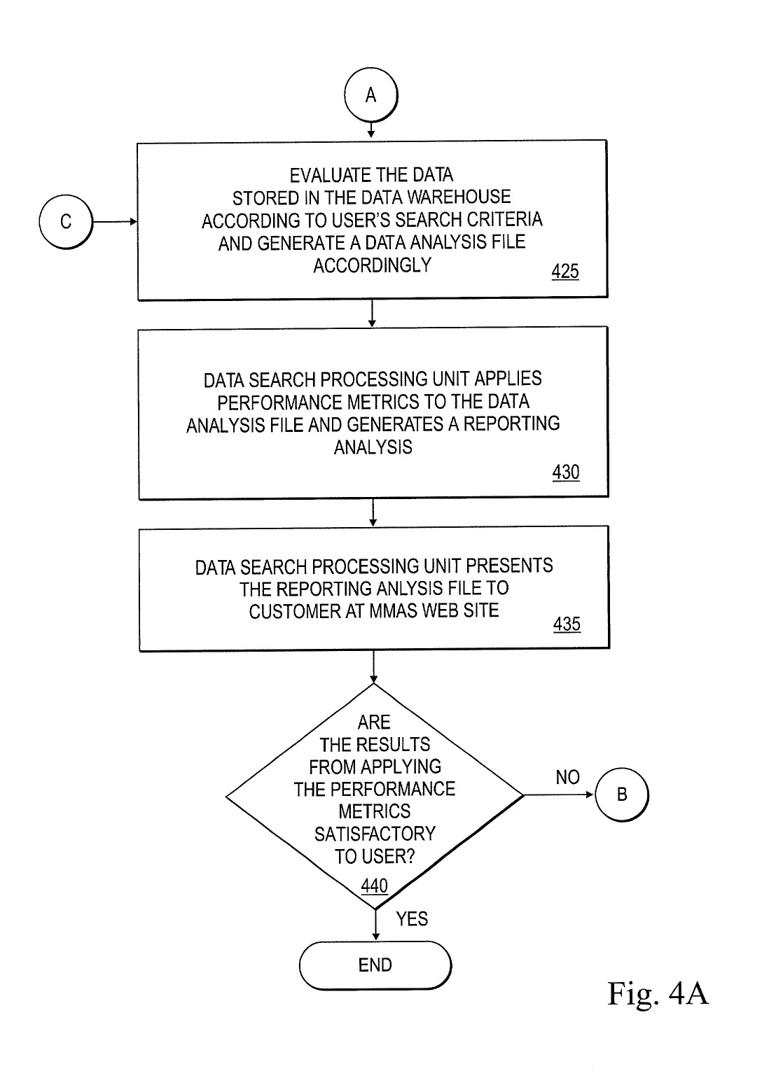

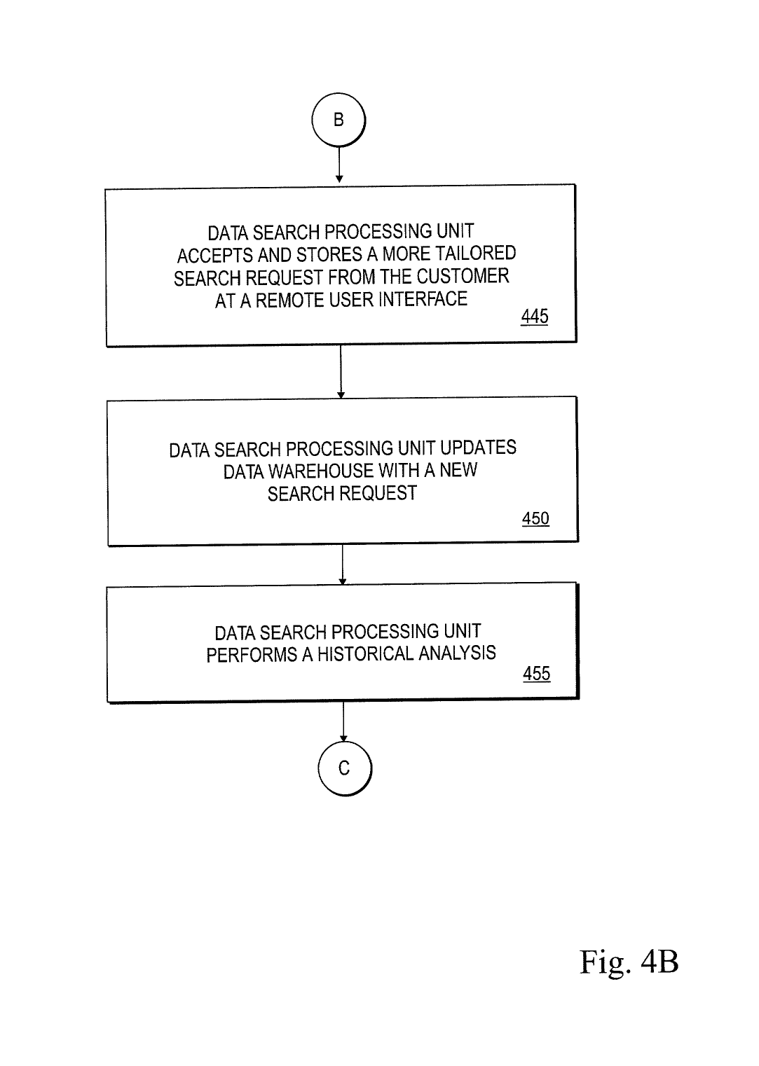

FIGS. 4, 4A and 4B illustrate operations performed by the Marketing Response System according to one embodiment of the invention. While FIGS. 4, 4A and 4B will be described with reference to the Market Metrics and Analysis System and other components of a web-based Market Metrics and Analysis System, it is understood that this system is exemplary in nature and that the invention is not limited to this specific system configuration. In addition, it should be understood that the operations performed by the Marketing Response System are to a certain extent dependent upon the implementation of the system itself, and thus, the invention is not limited to the specific operations illustrated in FIGS. 4, 4A and 4B.

In FIG. 4 illustrates some of the operations performed by the web-based Market Metrics and Analysis System of FIG. 3. Prior to describing block 400, it should be understood that the Internetworks searched in this system (e.g., Internet) is constantly changing and among these changes, new pertinent information to the user may be added. For this reason, the Market Metrics and Analysis System constantly searches a multitude of sources by way of search engines (e.g., CNET Search, Yahoo, etc.) for any new information that may be of use to any potential customer. In block 400, the MMAS utilizes its aggregation device, as depicted in FIG. 3, by aggregating the data gathered by these sources. The MMAS may conduct its own searches and aggregate its results or purchase this information, when found economically beneficial. From block 400, control passes to block 405.

In block 405, the aggregated data from block 400 is cleaned. This process includes extracting, cleansing, transforming and loading the web-page results. In the process of extracting, the resulting web-pages are parsed and processed to accurately extract meta-data (e.g., author, publication date, title, etc.) as well as the actual body of the document. The cleansing process removes any superfluous navigational and advertising elements, unlike existing state of the art “search engines.” From block 405, control passes to block 410.

In block 410, the aggregated data that has been cleaned is stored in a data warehouse. The data warehouse stores and keeps track of the information collected from each submitted search request from each customer. This information is often saved onto its own individual memory space, which is separate and confidential from all other customers in the MMAS database. In this embodiment, the MMAS may have a storage facility/database, in which it stores search information in a separate memory space at a different memory location within the database pertaining to each client. Anytime a customer of the system submits a change to a particular search, its respective memory space in the data warehouse is updated to reflect that change. This process will be further explained below.

As shown in FIG. 3, the data search-processing unit 330 indirectly connects with the data warehouse 325. It should be understood that the DSPU 330 and the data warehouse 325 could be implemented as one containment, but could also be implemented with some components at remote locations that communicate over a communication link, satellite, wireless network, etc. This data warehouse, for obvious security reasons, has a direct line of electronic communication with the DSPU 330. The data search-processing unit 330 maintains constant interaction with its data warehouse 325 because within the data warehouse 325, information pertaining to each customer's search criteria is stored on its own individual memory space. The amount of memory space that exists within the data warehouse 325 is dependent on the size of the data warehouse 325 implemented in that embodiment of the invention. From block 410, control passes to block 415.

In block 415, the data search-processing unit accepts search criteria from user at the remote user-interface. The Market Metrics and Analysis System first establishes a connection with the user at a remote user interface. However, as previously explained, a connection between any components of the MMAS including data search-processing unit with a remote user interface does not require a physical connection. For example, utilization of a satellite dish or any other wireless-type system that can maintain a secure and privileged connection may also be used to connect these components. Assuming a connection is made, a user accesses the MMAS website. The user must first set up an account with the MMAS.

Without a present existing account, the user cannot gain access to the protected and privileged fields within the website (e.g., protected web site). An account can be set up in a variety of ways, such as the user first registering with the MMAS along with setting up a username and password. Once registration is completed, the user can log into the protected web site of the website to access a multitude of information pertaining to the types of searches that are provided for by the system. The information posted on the website may include the types of narrowly tailored searches that are available to a customer. The protected web site of the website may also be accessed for completing and submitting a selected narrowly tailored search, in which the results arising from that submission is sensitive to the input provided by the user.

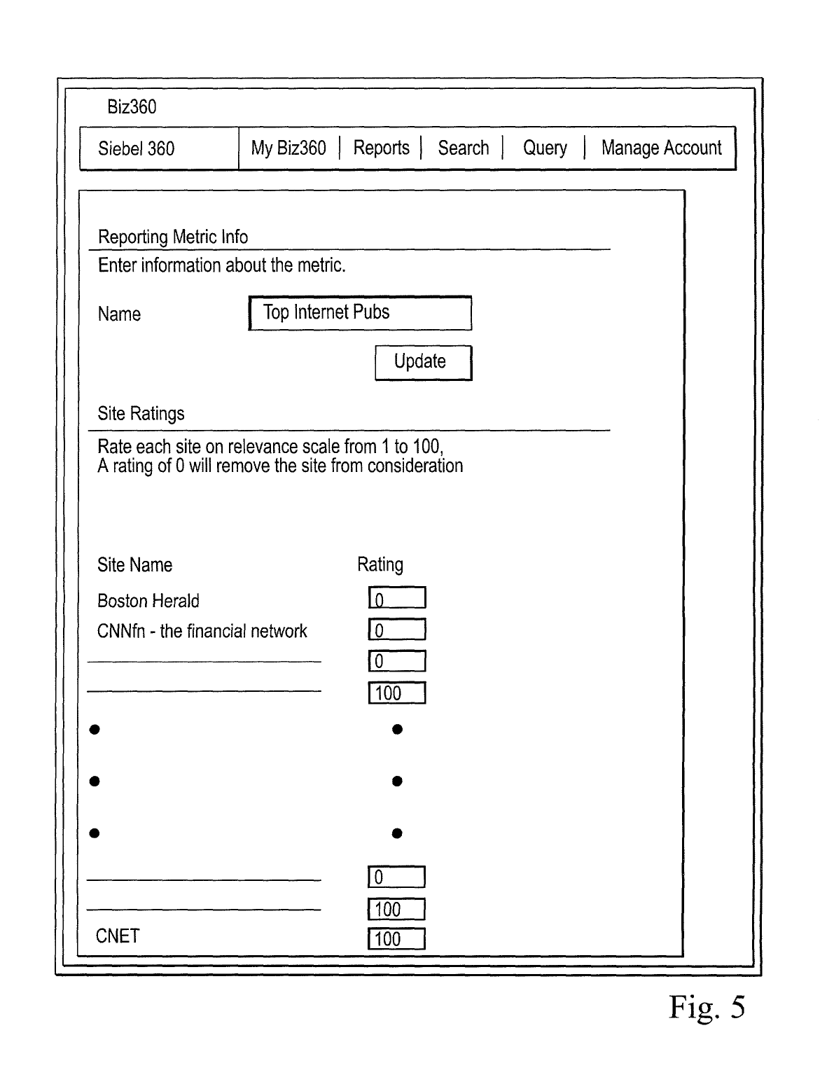

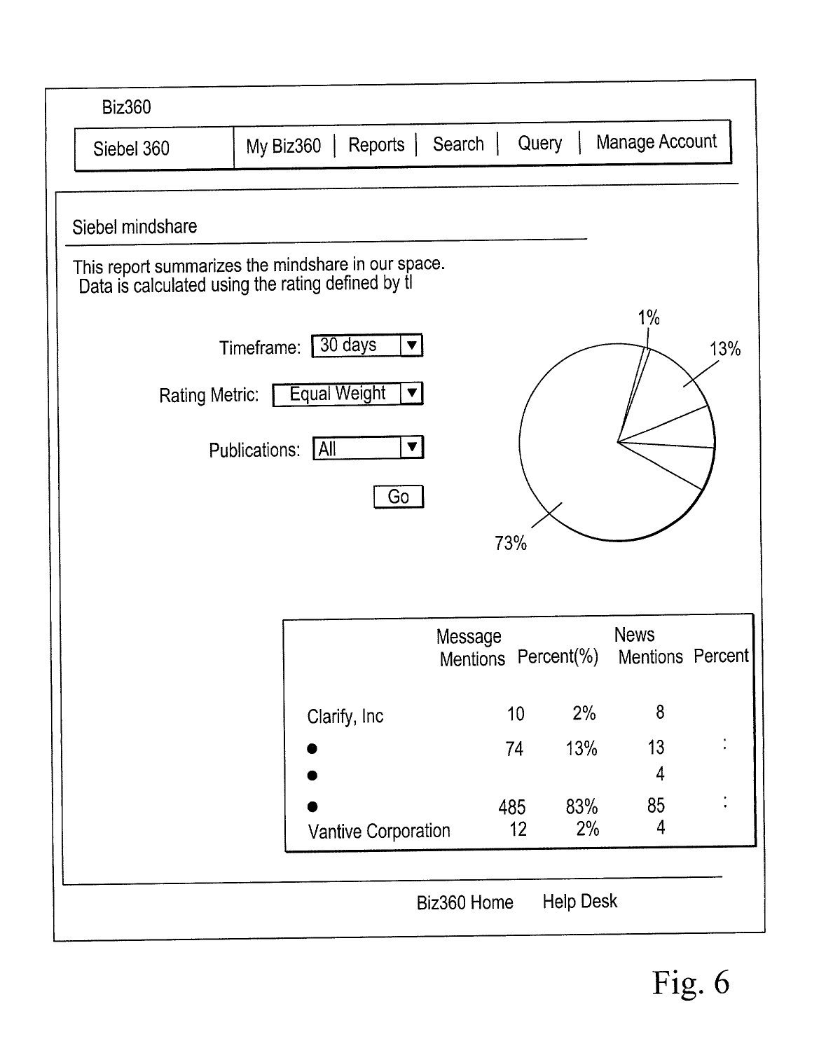

With reference to FIGS. 5 and 6, these Figures are example user-interface screens used to show what the screen at the remote user interface might look like during this stage of the searching process. FIG. 5 is an example user-interface screen on the Market Metrics and Analysis System web site that prompts the user to complete input fields that are necessary to complete the desired search and produce the proper metrics and analysis. This particular web site is an example of one type of reporting metric performance screen. In this example, the web site prompts the user for “site ratings” of relevance on a scale from 1 to 100, where entering zero would remove the site from consideration. This information is crucial in order to narrowly tailor the search so that only an efficient search can be conducted. FIG. 6 is an additional example user-interface screen on the Market Metrics and Analysis System website that prompts the user to complete input fields that are necessary to properly and effectively calculate mindshare. Notice that the user may select the timeframe, the rating metric (ranging from equal weight to a substantially unequal weight per publication) and allows the user to select which publications to include in the mindshare analysis.

These two Figures are only examples of what the user may expect to see displayed at the website when submitting a search to the Market Metrics and Analysis System for processing. Once the user decides on the type of search desired and completes any necessary fields asked for on the protected web site on the website, the form is submitted to the data search-processing unit by the user clicking on the “OK” and/or “SUBMIT” button(s). It should be understood that in one implement, those buttons may have been designated to submit the search request, however different buttons may have been implemented according to the design of the system (e.g., to compensate for differing languages). From block 415, control passes to block 420.

In block 420, the Market Metrics and Analysis System stores the information collected from each submitted search request, based on the user-given preferences. This information is often saved onto a memory space, which is separate and confidential from all other user search files in the data warehouse. In this embodiment, the MMAS may have a storage facility/database, in which it stores each specific search request for each user in a separate memory location at a different memory space within the data warehouse. Anytime a user of the system submits a change to a particular search request, its respective memory space in the data warehouse is updated to reflect that change. From block 420, control passes to block 425 of FIG. 4A.

FIG. 4A illustrates additional operations performed by the web-based Market Metrics and Analysis System of FIG. 3. At block 425, the data search-processing unit generates a data analysis upon the stored data in the data warehouse used in the system, according to the user's search criteria. The DSPU uses its data analysis module to conduct any data analysis functions. This data analysis module described herein, may be implemented by using software or hardware. The data analysis module incorporates search criteria that it attains from the DSPU and searches through a multitude of data stored in the data warehouse. The way in which this analysis is performed is unique in comparison with any current existing search methods. In this particular embodiment, an analysis includes performing a search according to three criteria. At this point, it should be understood that these types of search analyses may be applied not only to numeric- and text-based documents, but also and not limited to media-based and audio-based documents.

One internal analysis method used for conducting a narrowly tailored search is the checking for any documents that may arise showing a relationship between the user's line of business and any competitors that are within the same field. Another internal data analysis method used for a narrowly tailored search is the actual searching for keywords that the user may input at the remote user interface. The user may desire to conduct a search in accordance with specific terms.

One more example of an internal data analysis method used for a narrowly tailored search is where the MMAS and/or the user can analyze all feedback from the conducted search. The user may decide whether the search was best suited for the desired application or the user may allow the MMAS employ its own tailoring search methods in conducting the more narrowly tailored search. For example, in one search the user may want to analyze for him/herself all possible matches found by the searching system upon any criteria submitted by the user. This internal data analysis method will allow the user to review all search results and pick which ones are applicable and discard any that are found inapplicable. In another search, the user may not want to analyze for him/herself all the possible matches found by the searching system. In this implementation, the MMAS automatically chooses for the user (upon its own discretion), which search results it believes as being applicable to the customer user according to the prior-submitted search criteria. From block 425, control passes to block 430.

Block 430 includes the data search-processing unit performing the method of applying a multitude of performance metrics to the resultant data analysis, in accordance with the input given by the user. The performance metrics device indirectly (through the DSPU) keeps track of the preferences submitted earlier by the user. An example is where the user may desire to find out how many times the researched company or a competitor's company has been published in a recent newspaper publication. The user is asked how much weight should be put on any specific publication. Some publications are granted more importance because they are tailored to a specific area of expertise. Thereby, the user can control the amount of feedback coming from the MMAS and can weight each publication differently, according to its importance to the user. The performance metrics formats the resulting data in accordance with the user's previously submitted desired preferences to the data search-processing unit. It should be understood that a multitude of different types of performance metric criteria can be applied using this performance metrics device and is not limited to the example described above. A reporting analysis file is generated pertaining to the actions described above. This reporting analysis file is saved in the data warehouse according to the preferences initially inputted by the user, at the remote user interface. From block 430, control passes to block 435.

In Block 435, the data search-processing unit presents the pre-generated reporting analysis file to the customer at the MMAS website, accessible by a remote user interface. There are a many different ways that the data search-processing unit may present these metrics results to the customer via a remote user interface. One example is where the Market Metrics and Analysis System could display (upon privileged and secure access) uses its own web site to display all search results pertaining to each respective customer. A privileged connection (e.g., via Internet) between the customer and the data search-processing unit would exist so that any communication between them would be confidential.

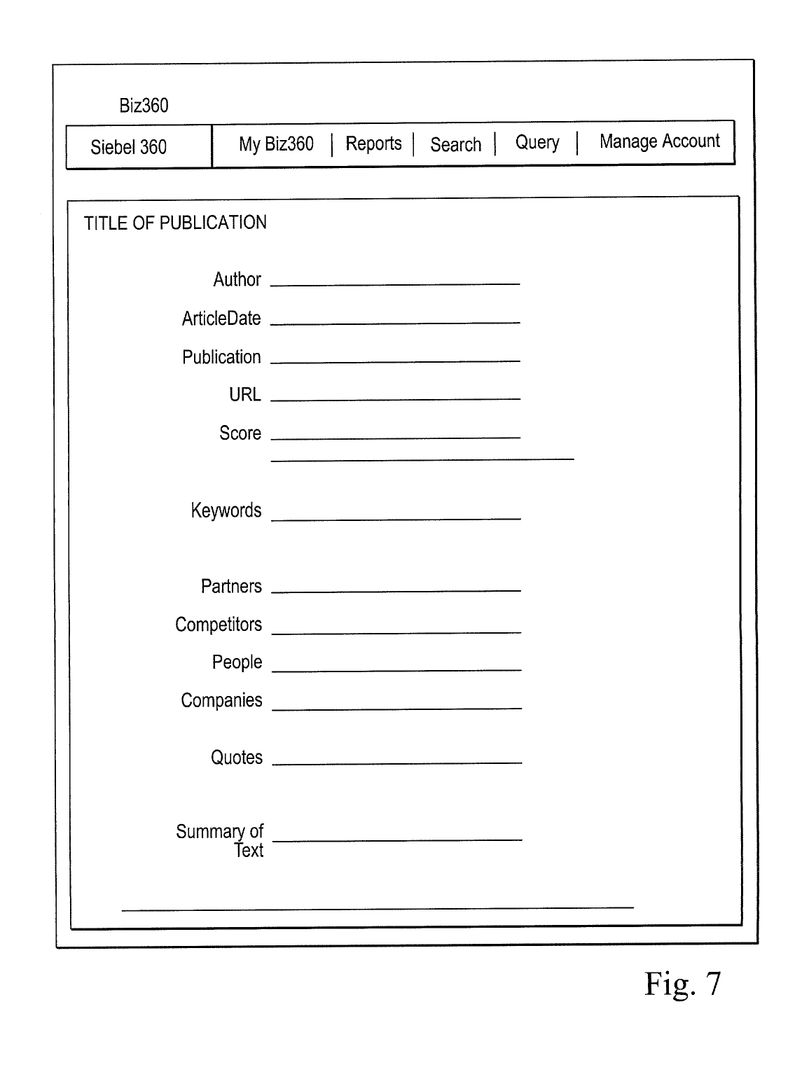

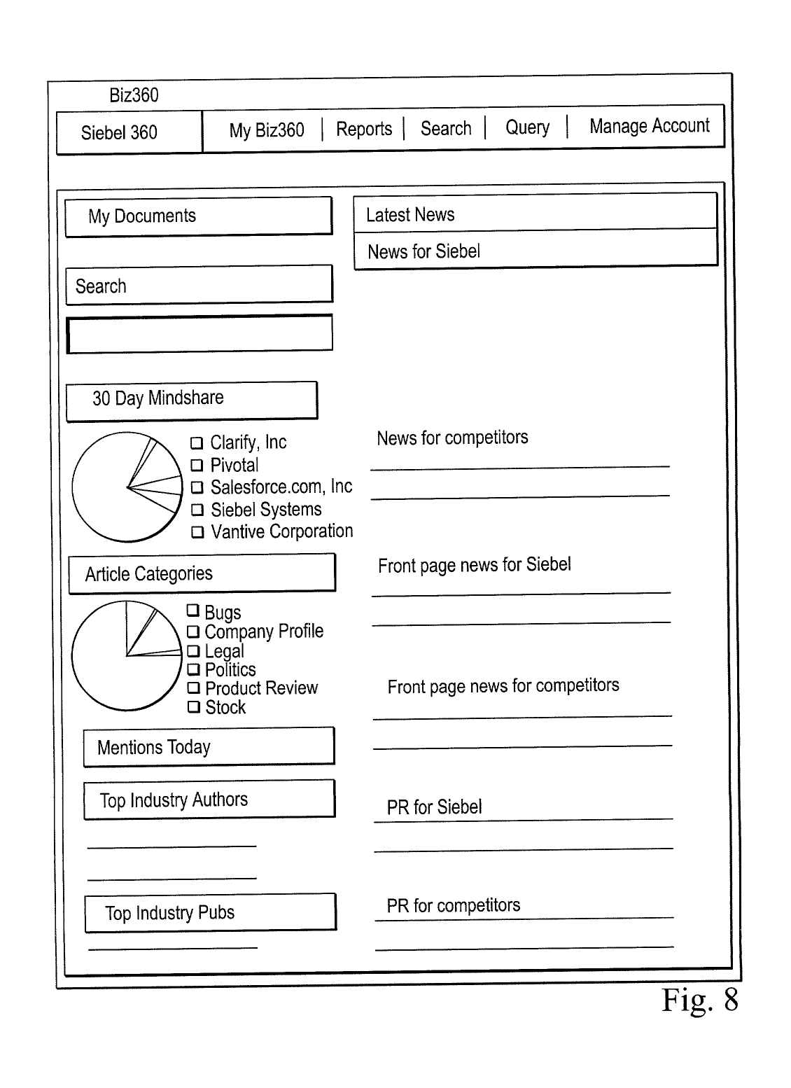

With reference to FIGS. 7 and 8, these Figures are example user-interface screens used to show what the screen at the remote user interface might look like at various stages of reporting a completed search. FIG. 7 is an example user-interface screen on the Market Metrics and Analysis System web site that displays to the user the summary of a publication that is related to the user's search. Notice that this example screen displays multiple sections of information including the author of the article, the date of the article, any possible competitors (if any) and much more. The MMAS formats the information and displays it in a way that is beneficial to the user conducting the search. This particular web site is shown to include these eleven sections, however in another embodiment, there may be more or less sections.

FIG. 8 is an additional example user-interface screen on the Market Metrics and Analysis System web site that textually and graphically displays to the user a summary of a multitude of criteria pertaining to the user's search. Notice that the graphical illustration denotes a thirty-day mindshare and ranks five different competitors in a pie graph. It should be understood that not only could the graphical illustration vary from one embodiment to another, but also the number of competitors involved in the illustration could change in accordance with the user's preference. From block 435, control passes to block 440.

Block 440 is an inquiry to the user at the remote user interface where the user gives additional direction to the data search process. The Market Metrics and Analysis System web site, as explained previously in block 430 will apply its performance metrics function to every submitted search request by the user, according to the criteria tailored by the user. One the MMAS completes the desired search according to the criteria given by the user, the results will be displayed as explained previously in block 435. The user now has a chance to review these searches results and decides whether another search is necessary. If the results are found satisfactory to the user after the completion of the search, then the search process is complete. If the results are not satisfactory to the user after completion of the search, then control passes to block 445 of FIG. 4B.

FIG. 4B illustrates exemplary operations performed by the web-based Market Metrics and Analysis System of FIG. 3 if user is not satisfied with original search results, according to one embodiment of the invention. At block 445, a new data search is performed by the MMAS. The data search-processing unit will accept and then execute a more tailored search request that is submitted by the user from the user at the remote user interface. This block performs the same search as described in block 415, but with the additional terms submitted by the user. From block 445, control passes to block 450.

At block 450, the data search-processing unit updates its data warehouse with the new search request. This updated data includes newly submitted terms used to conduct a more narrowly tailored search. The basic rationale of storing these newly submitted search terms is to track all search requests of all users in its own memory space within the data warehouse. From block 450, control passes to block 455.

At block 455, the data search-processing unit performs a historical analysis. A historical analysis has many uses in tracking what type of documents the user has disregarded and which is beneficial from past searches, thereby increasing the time-efficiency of each subsequently search performed. For example, user may have submitted an original search of the “Nova,” which may be a competitor that sells electronic organizers. Its search results may return millions of documents where a majority of them deal with the country of “Nova Scotia” or a biotechnological pharmaceutical service or is a provider of Internet services. Obviously, this is not the desired result that the user is expecting. The user then refines the search to include “Nova, the electronic organizer company.” After this search, the results are desirable. The search-processing unit will make note and remember (by storing in data warehouse 325) that the user liked the results of this search and did not like the search of simply “Nova.” Now, for every search that the user submits (until resetting the search) the MMAS will automatically display only the results regarding “Nova, the electronic organizer company” even when the user only submits “Nova” as its search criteria. From block 455, control passes back to block 435 of FIG. 4A and proceeds on through the process as previously described until a desired search result is found by the user.

The techniques shown in the figures can be implemented using code and data stored and executed on computers. Such computers store and communicate (internally and with other computers over a network) code and data using machine-readable media, such as magnetic disks; optical disks; random access memory; read only memory; flash memory devices; electrical, optical, acoustical or other form of propagated signals (e.g., carrier waves, infrared signals, digital signals, etc.); etc. Of course, one or more parts of the invention may be implemented using any combination of software, firmware, and/or hardware.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting on the invention.

What is claimed is:

1. A method of providing personalized access on an automated networked system comprising:
aggregating data gathered from networked sources, wherein said networked sources includes at least one user at a computer networked interface;
cleaning said aggregated data;
storing said cleaned data;
generating a data analysis from said stored data, wherein said data analysis is based on data gathered from the user; and
generating a reporting analysis, wherein the reporting analysis is based on data gathered from the user and the results from said data analysis.

2. The method of claim 1, wherein said report analysis applies performance metrics according to the data gathered from user.

3. The method of claim 1, wherein each reporting analysis is stored in consecutive order starting with the first reporting analysis conducted.

4. The method as set forth in claim 1, wherein said data analysis is updated subsequent to any additional reporting analysis conducted after the first reporting analysis is completed.

5. The method as set forth in claim 1, wherein the said reporting analysis focuses on particular industries and may be any of: marketing, support, finance, research and development, sales or executive.

6. The method as set forth in claim 5, wherein the said reporting analysis focuses on particular departments within the particular industries and may be any of: high-technology, electronics, automotive, financial services or entertainment.

7. The method as set forth in claim 1, wherein the data gathered from said user may include publication listings and/or the timeframe in which these publications have been published.

8. An automated networked system for providing personalized access comprising:
a data aggregating device from networked sources, wherein said networked sources includes at least one user at a computer networked interface;
a data cleaning device to clean said aggregated data;
a data warehouse to store the cleaned data;
a data analysis module to generate a data analysis from said stored data, wherein said data analysis is based on data gathered from the user; and
a data search processing unit that generates a reporting analysis, wherein the reporting analysis is based on data gathered from the user and the results from said data analysis.

9. The system of claim 8, wherein said report analysis applies performance metrics according to the data gathered from user.

10. The system of claim 8, wherein each reporting analysis is stored in consecutive order starting with the first reporting analysis conducted.

11. The system as set forth in claim 8, wherein said data analysis is updated subsequent to any additional reporting analysis conducted after the first reporting analysis is completed.

12. The system as set forth in claim 8, wherein the said reporting analysis focuses on particular industries and may be any of: marketing, support, finance, research and development, sales or executive.

13. The system as set forth in claim 12, wherein the said reporting analysis focuses on particular departments within the particular industries and may be any of: high-technology, electronics, automotive, financial services or entertainment.

14. The system as set forth in claim 8, wherein the data gathered from said user may include publication listings and/or the timeframe in which these publications have been published.

15. An apparatus including computer readable media, with executable instructions therein, which when executed by a processing device causes the processing device to:
aggregate the data gathered from networked sources, wherein said networked sources includes at least one user at a computer networked interface;
clean said aggregated data;
store said cleaned data;
generate a data analysis from said stored data, wherein said data analysis is based on data gathered from the user; and
generate a reporting analysis, wherein the reporting analysis is based on data gathered from the user and the results from said data analysis.

16. The apparatus of claim 15, wherein said report analysis applies performance metrics according to the data gathered from user.

17. The apparatus of claim 15, wherein each reporting analysis is stored in consecutive order starting with the first reporting analysis conducted.

18. The apparatus as set forth in claim 15, wherein said data analysis is updated subsequent to any additional reporting analysis conducted after the first reporting analysis is completed.

19. The apparatus as set forth in claim 15, wherein the said reporting analysis focuses on particular industries and may be any of: marketing, support, finance, research and development, sales or executive.

20. The method as set forth in claim 19, wherein the said reporting analysis focuses on particular departments within the particular industries and may be any of: high-technology, electronics, automotive, financial services or entertainment.

21. The method as set forth in claim 15, wherein the data gathered from said user may include publication listings and/or the timeframe in which these publications have been published.
